(19) United States
(12) Patent Application Publication
(10) Pub. No.: US 2025/0326904 A1
(43) Pub. Date: Oct. 23, 2025

(54) PROTECTIVE FILM

(71) Applicants: SK microworks Co., Ltd., Jincheon-gun (KR); SK MICROWORKS SOLUTIONS CO., LTD., Cheonan-si (KR)

(72) Inventors: Sungjin CHUNG, Suwon-si (KR); Kweonhyung HAN, Suwon-si (KR); Kwangho JANG, Suwon-si (KR); Hongyoul CHO, Cheonan-si (KR); Taehoon KIM, Cheonan-si (KR)

(73) Assignees: SK microworks Co., Ltd., Jincheon-gun (KR); SK MICROWORKS SOLUTIONS CO., LTD., Cheonan-si (KR)

(21) Appl. No.: 19/240,456

(22) Filed: Jun. 17, 2025

Related U.S. Application Data
(63) Continuation of application No. PCT/KR2023/013474, filed on Sep. 8, 2023.

(30) Foreign Application Priority Data
Dec. 20, 2022 (KR) 10-2022-0179453

(51) Int. Cl. C08J 5/18; C08J 7/04; C08J 7/046; C08K 5/3475

(52) U.S. Cl. CPC C08J 5/18; C08J 7/042; C08J 7/046; C08K 5/3475; C08J 2333/08; C08J 2377/00

(57) ABSTRACT

A protective film includes a protective layer. The protective layer includes a polyether-block-amide copolymer resin. YIₙ is a yellowness index measured after irradiating the protective layer with UVB-313EL light at an intensity of 0.68 W/m² for n hours. The protective layer has a yellowness index deviation (dvY) of 2.5 or less, as defined by Equation (1):

Equation (1):

$$dvY = {YI}_{max} - {YI}_{min}$$

wherein:
YIₘₐₓ is the maximum value among the yellowness indices YI₀, YI₂₄, YI₄₈, YI₇₂, YI₁₄₄, YI₂₁₆, YI₃₁₂, and YI₃₈₄; and
YIₘᵢₙ is the minimum value among the same set of yellowness indices. The film can exhibit excellent yellowing resistance and mechanical properties even when exposed to ultraviolet rays for a long period of time.

### CROSS-REFERENCE TO RELATED APPLICATIONS

This application claims the benefit under 35 U.S.C. § 119 (a) of Korean Patent Application No. 10-2022-0179453, filed on Dec. 20, 2022. This application is also a National Stage entry under 35 U.S.C. § 371 of International Application No. PCT/KR2023/013474, filed on Sep. 8, 2023, in the Korean Intellectual Property Office. The entire disclosure of the aforementioned applications is incorporated herein by reference for all purposes.

### BACKGROUND

### 1. Field

The present disclosure relates to a protective film.

### 2. Description of Related Art

The statements in this section merely provide background information related to the present disclosure and do not necessarily constitute prior art.

Conventionally, in order to protect the painted surface applied to the exterior of vehicles, a film laminate composed of materials such as polyurethane (TPU) or polyvinyl chloride (PVC) has been applied. However, the elastic properties of such film laminates vary significantly depending on environment conditions, particularly temperature fluctuations, when adhered to the painted surfaces. These variations often lead to difficulties in installation. Even when the ambient temperature is controlled through indoor air conditioning or localized heating during winter, challenges remain with respect to work efficiency, completeness, and final quality.

Furthermore, materials such as polyurethane and polyvinyl chloride are prone to yellowing due to their inherent properties, which can result in perceptible color changes on the painted surface after application. Although efforts have been made to improve the light resistance of the top coating layer and the adhesive layer of the films or film laminates, yellowing remains an issue after application to vehicle surfaces.

The background information described herein is technical information obtained or developed by the inventors in the course of conceiving the present disclosure. It is not necessarily intended to represent publicly known prior art or conventional technology available to the general public prior to the filing of the present application.

### SUMMARY

An object of the present disclosure is to provide a protective film that maintains excellent yellowing resistance and mechanical properties even after prolonged exposure to ultraviolet radiation.

In one general aspect, a protective film includes a protective layer and the protective layer includes a polyether-block-amide copolymer resin. YIₙ is a yellowness index measured after irradiating the protective layer with UVB-313EL light at an intensity of 0.68 W/m² for n hours. The protective layer has a yellowness index deviation (dvY) of 2.5 or less, as defined by Equation (1):

$$dvY = {YI}_{max} - {YI}_{min} \qquad Equation ( 1 )$$

YIₘₐₓ is the maximum value among the yellowness indices YI₀, YI₂₄, YI₄₈, YI₇₂, YI₁₄₄, YI₂₁₆, YI₃₁₂, and YI₃₈₄; and YIₘᵢₙ is the minimum value among the same set of yellowness indices.

The YIₘₐₓ is the maximum value, and the YIₘᵢₙ is the minimum value, among YIₙ values measured at n=0, 24, 48, 72, 144, 216, 312, and 384 hours.

The YI value measured after 48 hours of UVB-313EL irradiation (YI₄₈) may be 2.8 or less.

The YI value measured after 384 hours of UVB-313EL irradiation (YI₃₈₄) may be 3.5 or less.

The protective layer may have a haze deviation (dvH) of 5% or less, as defined by Equation (2):

$$dvH = {H}_{max} - {H}_{min} \qquad Equation ( 2 )$$

Hₙ is a haze value measured after irradiating the protective layer with UVB-313EL light at an intensity of 0.68 W/m² for n hours.

Hₘₐₓ is the maximum value among H₀, H₂₄, H₄₈, H₇₂, H₁₄₄, H₂₁₆, H₃₁₂, and H₃₈₄; and Hₘᵢₙ is the minimum value among the same set of haze values.

The maximum haze value (Hₘₐₓ) among H₀, H₂₄, H₄₈, H₇₂, H₁₄₄, H₂₁₆, H₃₁₂, and H₃₈₄ may be 7% or less.

The protective layer may further include an optical absorber, and the protective layer may have a transmittance of 20% or less for light having a wavelength of 360 nm.

The protective layer may further include an optical absorber, and the optical absorber may be present in an amount of 0.1 to 5 parts by weight per 100 parts by weight of the polyether-block-amide resin.

The protective film may further include a coating layer disposed on the protective layer, and an adhesive layer disposed beneath the protective layer.

The protective film may be a paint protection film.

The optical absorber may include at least one selected from the group consisting of a benzotriazole-based compound, an oxanilide-based compound, a hydroxybenzophenone-based compound, a hydroxyphenyltriazine-based compound, a benzoic acid ester-based compound, and combinations thereof.

The protective layer may have a thickness in a range of 1 μm to 2,000 μm.

In another general aspect, a protective film includes: a protective layer; a coating layer disposed on the protective layer; and an adhesive layer disposed beneath the protective layer. The protective layer has a haze deviation (dvH) of 5% or less, as defined by Equation (1): dvH=Hₘₐₓ−Hₘᵢₙ. Hₙ is a haze value measured after irradiating the protective layer with UVB-313EL light at an intensity of 0.68 W/m² for n hours, Hₘₐₓ is the maximum value among H₀, H₂₄, H₄₈, H₇₂, H₁₄₄, H₂₁₆, H₃₁₂, and H₃₈₄; and Hₘᵢₙ is the minimum value among the same set of haze values. The protective film may be a paint protection film.

The maximum haze value (Hₘₐₓ) among H₀, H₂₄, H₄₈, H₇₂, H₁₄₄, H₂₁₆, H₃₁₂, and H₃₈₄ may be 7% or less.

The protective layer may further include an optical absorber and a polyether-block-amide copolymer resin, and the protective layer may have a transmittance of 20% or less for light having a wavelength of 360 nm.

The optical absorber may be present in an amount of 0.1 to 5 parts by weight per 100 parts by weight of the polyether-block-amide resin.

According to the present disclosure, a protective film can maintain excellent optical characteristics and mechanical properties even when exposed to ultraviolet radiation for a long period of time.

### BRIEF DESCRIPTION OF THE DRAWINGS

FIG. 1 illustrates a graph showing results of measurement of yellowness index depending on the light irradiation time in Examples and Comparative Examples;

FIG. 2 illustrates a graph showing results of measurement of haze depending on the light irradiation time in Examples and Comparative Examples; and

FIG. 3 illustrates a graph showing results of measurement of transmittance depending on the wavelength of inspection light in Examples and Comparative Examples.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

An object of the present disclosure is to provide a protective film that maintains excellent yellowing resistance and mechanical properties even after prolonged exposure to ultraviolet radiation.

Hereinafter, embodiments are described in detail so that the present disclosure may be easily implemented by those having ordinary skill in the art to which the present disclosure pertains. However, the present disclosure may be embodied in various different forms and is not limited to the embodiments described herein.

Herein, the terms “about,” “substantially,” and the like indicating the extent are used in a sense at or close to the numerical value when preparation and material tolerances inherent in the meanings mentioned are presented, and are used to prevent unscrupulous infringers from unfairly utilizing the disclosure contents in which exact or absolute values are mentioned in order to aid in the understanding of the present disclosure.

Throughout this specification, the term “combination of the protective layer” included in the expressions in the Markush format refers to a mixture or combination of one or more selected from the group consisting of components described in the expressions in the Markush format, and means including one or more selected from the group consisting of the components.

Throughout this specification, “A and/or B” means “A, B, or A and B.”

Throughout this specification, terms such as “first” and “second,” or “A” and “B” are used to distinguish the same terms from each other unless otherwise specified.

Herein, B being located on A means that B is located in contact with A or that B is located on A with a further layer interposed therebetween, and is not interpreted as being limited to B being located in contact with the surface of A.

Herein, singular expressions are interpreted to include the singular or plural as interpreted by the context, unless specified otherwise.

The resin described herein is interpreted to mean the resin itself and compounds derived from the resin. By way of example, the polyether-block-amide copolymer resin described herein means a polyether-block-amide copolymer resin and derivatives of the protective layer.

Herein, the OOO-based compound means an OOO compound itself and/or derivatives of the protective layer derived from OOO. By way of example, the benzotriazole-based compound refers to benzotriazole and/or compounds derived from benzotriazole.

The inventors of the present disclosure experimentally ascertained that, when the yellowness index deviation, etc. of a protective layer in a protective film is controlled, excellent yellowing resistance and mechanical properties of the film may be maintained despite exposure of the protective layer to ultraviolet radiation for a long period of time, culminating in the present disclosure.

Hereinafter, a detailed description will be given of the present disclosure.

A protective film of the present disclosure includes a protective layer.

### Optical Characteristics of Protective Layer

The protective layer includes a polyether-block-amide copolymer resin.

YIₙ is the yellowness index measured after irradiating the protective layer with UVB-313EL light at an intensity of 0.68 W/m² for n hours.

The protective layer has a yellowness index deviation (dvY) of 2.5 or less, as defined by Equation (1):

$$dvY = {YI}_{max} - {YI}_{min} \qquad Equation ( 1 )$$

In Equation (1), YIₘₐₓ is the maximum value among the yellowness indices YI₀, YI₂₄, YI₄₈, YI₇₂, YI₁₄₄, YI₂₁₆, YI₃₁₂, and YI₃₈₄.

YIₘᵢₙ is the minimum value among the same set of yellowness indices.

According to the present disclosure, it is possible to control the yellowness index deviation (dvY) of a protective layer. When the protective layer is applied to the film, the extent of increase in yellowness index of the film due to long-term exposure to ultraviolet radiation may be controlled, and the mechanical properties of the film, such as flexibility, may be maintained within a stable range. Thus, the film may have long-term durability suitable for application to a PPF (paint protection film) for objects that may be exposed to the outside for a long time, such as automobiles.

A method of calculating the dvY of the protective layer is described below.

The yellowness index of the protective layer is measured in D65/10 mode according to ASTM E313. The protective layer is irradiated with UVB-313EL light at an intensity of 0.68 W/m² using a UVB lamp. The wavelength of UVB-313EL may be in the range of 280 nm to 360 nm. The yellowness index of the protective layer when the cumulative light exposure time is 24 hours, 48 hours, 72 hours, 144 hours, 216 hours, 312 hours, and 384 hours is measured in D65/10 mode according to ASTM E313. Among the measured values, the maximum value is set as YIₘₐₓ, and the minimum value is set as YIₘᵢₙ. The dvY value is calculated from YIₘₐₓ and YIₘᵢₙ.

For example, the UVB lamp may be a G15T82 from Sankyo Denki.

YIₘₐₓ may be the maximum value among the YIₙ values when n ranges from 0 to 384.

YIₘᵢₙ may be the minimum value among the YIₙ values when n ranges from 0 to 384.

The dvY of the protective layer may be 2.5 or less. The dvY of the protective layer may be 2.3 or less. The dvY of the protective layer may be 2 or less. The dvY of the protective layer may be 0.1 or more. The dvY of the protective layer may be 0.5 or more. As such, a protective film having excellent weather resistance may be provided.

The YIₘₐₓ of the protective layer may be 3.5 or less. The YIₘₐₓ of the protective layer may be 3.2 or less. The YIₘₐₓ of the protective layer may be 3 or less. The YIₘₐₓ of the protective layer may be 2.7 or less. The YIₘₐₓ of the protective layer may be 2.5 or less. The YIₘₐₓ of the protective layer may be 0.5 or more. As such, the extent of increase in yellowness index of the film due to long-term use may be reduced and brittleness of the film may be stably maintained.

The YIₘᵢₙ of the protective layer may be 0.1 or more. The YIₘᵢₙ of the protective layer may be 0.5 or more. The YIₘᵢₙ of the protective layer may be 2 or less.

The YI value measured after 48 hours of UVB-313EL irradiation (YI₄₈) of the protective layer may be 2.8 or less.

The protective layer having the controlled YI₄₈ according to the present disclosure may be suppressed in rapid yellowing and hardening due to exposure to ultraviolet radiation, substantially increasing the lifespan of the protective film.

The YI₄₈ of the protective layer may be 2.8 or less. The YI₄₈ of the protective layer may be 2.5 or less. The YI₄₈ of the protective layer may be 2.3 or less. The YI₄₈ of the protective layer may be 2 or less. The YI₄₈ of the protective layer may be 0.5 or more. The YI₄₈ of the protective layer may be 0.8 or more. As such, optical characteristics and mechanical properties of the film may be stably maintained long even when exposed to ultraviolet radiation for a long time.

The YI value measured after 384 hours of UVB-313EL radiation (YI₃₈₄) of the protective layer may be 3.5 or less. The YI₃₈₄ of the protective layer may be 3.2 or less. The YI₃₈₄ of the protective layer may be 3 or less. The YI₃₈₄ of the protective layer may be 2.8 or less. The YI₃₈₄ of the protective layer may be 2.5 or less. The YI₃₈₄ of the protective layer may be 2.3 or less. The YI₃₈₄ of the protective layer may be 2 or less. The YI₃₈₄ of the protective layer may be 0.5 or more. When the protective layer having the characteristics described above is applied to a protective film for a vehicle, the rate of degradation of the film may be stably controlled.

The yellowness index YI₀ of the protective layer may be 2 or less. The yellowness index of the protective layer may be 1.5 or less. The yellowness index of the protective layer may be 1.2 or less. The yellowness index of the protective layer may be 0.1 or more.

The yellowness index of the protective layer is measured in D65/10 mode according to ASTM E313.

The protective layer may have a haze deviation (dvH) of 5% or less, as defined by Equation (2):

$$dvH = {H}_{max} - {H}_{min} \qquad Equation ( 2 )$$

In Equation (2), Hₙ is the haze measured after irradiating the protective layer with UVB-313EL light at an intensity of 0.68 W/m² for n hours.

Hₘₐₓ is the maximum value among H₀, H₂₄, H₄₈, H₇₂, H₁₄₄, H₂₁₆, H₃₁₂, and H₃₈₄.

Hₘᵢₙ is the minimum value among H₀, H₂₄, H₄₈, H₇₂, H₁₄₄, H₂₁₆, H₃₁₂, and H₃₈₄.

The protective film having the controlled dvH may be suppressed in changes in optical characteristics over time due to exposure to ultraviolet radiation, allowing the color of the painted surface to remain vivid for a long time after attachment.

A method of calculating the dvH of the protective layer is described below.

The haze of the protective layer is measured using a haze meter according to ASTM D 1003. Then, the protective layer is irradiated with UVB-313EL light at a light output of 0.68 W/m² using a UVB lamp. The wavelength of UVB-313EL may be in the range of 280 nm to 360 nm. The haze of the protective layer when the cumulative light exposure time is 24 hours, 48 hours, 72 hours, 144 hours, 216 hours, 312 hours, and 384 hours is measured using a haze meter according to ASTM D 1003. Among the measured values, the maximum value is set as Hₘₐₓ, and the minimum value is set as Hₘᵢₙ. The dvH value is calculated from Hₘₐₓ and Hₘᵢₙ.

For example, the UVB lamp may be a G15T82 from Sankyo Denki.

Hₘₐₓ may be the maximum value among the Hₙ values when n ranges from 0 to 384.

Hₘᵢₙ may be the minimum value among the Hₙ values when n ranges from 0 to 384.

The dvH of the protective layer may be 5% or less. The dvH of the protective layer may be 4% or less. The dvH of the protective layer may be 3.5% or less. The dvH of the protective layer may be 3% or less. The dvH of the protective layer may be 2% or less. The dvH of the protective layer may be 0.1% or more.

The Hₘₐₓ of the protective layer may be 7% or less. The Hₘₐₓ of the protective layer may be 6% or less. The Hₘₐₓ of the protective layer may be 5% or less. The Hₘₐₓ of the protective layer may be 4.5% or less. The Hₘₐₓ of the protective layer may be 1% or more.

As such, the clarity of the film may be maintained at a certain level or more for a long period of time.

The Hₘᵢₙ of the protective layer may be less than 4.5%. The Hₘᵢₙ of the protective layer may be 4% or less. The Hₘᵢₙ of the protective layer may be 3.5% or less. The Hₘᵢₙ of the protective layer may be 0.5% or more.

The haze (H₀) of the protective layer may be less than 4.5%. The haze of the protective layer may be 4% or less. The haze of the protective layer may be 3.5% or less. The haze of the protective layer may be 3% or less. The haze of the protective layer may be 0.5% or more.

The haze of the protective layer is measured using a haze meter according to ASTM D 1003.

The protective layer may further include an optical absorber. The optical absorber is a material that is able to suppress degradation of the film by converting optical energy received from ultraviolet radiation into thermal energy.

The protective layer of the present disclosure may have controlled transmittance characteristics for light at a wavelength of 360 nm. For a protective layer having characteristics within a preset range in the present disclosure, the optical absorber in the protective layer may serve to stably absorb ultraviolet radiation, effectively reducing the rate at which deterioration of the optical characteristics and mechanical properties of the protective film progresses.

The transmittance of the protective layer may be measured using a UV-visible spectrophotometer. Specifically, measurement may be performed by placing a protective layer on the spectrophotometer, setting a transmission mode, and setting the inspection light wavelength to 300 nm to 800 nm. For example, the spectrophotometer may be a UV-2450 from Shimadzu.

The transmittance of the protective layer for light at a wavelength of 360 nm may be 20% or less. The transmittance of the protective layer may be 15% or less. The transmittance of the protective layer may be 10% or less. The transmittance of the protective layer may be 5% or less. The transmittance of the protective layer may be 0.01% or more. As such, a protective film with excellent long-term durability, suitable for use as a PPF for vehicles, etc., may be provided.

The transmittance of the protective layer for light at a wavelength of 450 nm may be 80% or more. The transmittance of the protective layer for light at a wavelength of 450 nm may be 82% or more. The transmittance of the protective layer for light at a wavelength of 450 nm may be 85% or more. The transmittance of the protective layer for light at a wavelength of 450 nm may be 87% or more. The transmittance of the protective layer for light at a wavelength of 450 nm may be 99% or less. As such, the protective film may exhibit optical characteristics suitable for use as a paint protection film.

### Mechanical Properties of Protective Layer

In the protective layer of the present disclosure, the difference between the storage modulus measured at room temperature and the storage modulus measured at a temperature higher or lower than room temperature may be controlled. The protective film having the characteristics described above may have stable flexibility at various temperatures. Thus, the painted surface may be reliably protected from impacts applied to the exterior of the vehicle during driving or car washing without film breakage or cracking. In addition, the protective film may be easily attached to the painted surface without performing additional processes such as local cooling or heating, resulting in superior processability compared to conventional protective films.

The storage modulus of the protective layer is measured according to ASTM D4065.

The ratio of the storage modulus of the protective layer measured at 50° C. relative to the storage modulus of the protective layer measured at 20° C. may be 0.7 or more. The ratio of the protective layer may be 0.73 or more. The ratio of the protective layer may be 0.75 or more. The ratio of the protective layer may be 1.1 or less. The ratio of the protective layer may be 1 or less. The ratio of the protective layer may be 0.95 or less.

The ratio of the storage modulus of the protective layer measured at 40° C. relative to the storage modulus of the protective layer measured at 20° C. may be 0.75 or more. The ratio of the protective layer may be 0.78 or more. The ratio of the protective layer may be 0.8 or more. The ratio of the protective layer may be 1.1 or less. The ratio of the protective layer may be 1.05 or less. The ratio of the protective layer may be 0.98 or less.

As such, convenience of attaching the protective film in a working environment requiring high temperatures may be improved.

The ratio of the storage modulus of the protective layer measured at 30° C. relative to the storage modulus of the protective layer measured at 20° C. may be 0.8 or more. The ratio of the protective layer may be 0.85 or more. The ratio of the protective layer may be 1.2 or less. The ratio of the protective layer may be 1.1 or less.

The ratio of the storage modulus of the protective layer measured at 10° C. relative to the storage modulus of the protective layer measured at 20° C. may be 0.9 or more. The ratio of the protective layer may be 0.95 or more. The ratio of the protective layer may be 0.98 or more. The ratio of the protective layer may be 1.3 or less. The ratio of the protective layer may be 1.2 or less.

The ratio of the storage modulus of the protective layer measured at 0° C. relative to the storage modulus of the protective layer measured at 20° C. may be 1 or more. The ratio of the protective layer may be 1.05 or more. The ratio of the protective layer may be 1.1 or more. The ratio of the protective layer may be 1.5 or less. The ratio of the protective layer may be 1.4 or less. The ratio of the protective layer may be 1.35 or less.

As such, the painted surface may be reliably protected without film breakage even in a low-temperature environment. Also, the protective film may be easily attached to the painted surface in a relatively low-temperature working environment.

The protective layer may have a storage modulus of 25 MPa or more as measured at 20° C. The storage modulus of the protective layer may be 30 MPa or more. The storage modulus of the protective layer may be 110 MPa or less. The storage modulus of the protective layer may be 100 MPa or less.

The protective layer may have a storage modulus of 25 MPa or more as measured at 30° C. The storage modulus of the protective layer may be 30 MPa or more. The storage modulus of the protective layer may be 110 MPa or less. The storage modulus of the protective layer may be 100 MPa or less.

The protective layer may have a storage modulus of 20 MPa or more as measured at 40° C. The storage modulus of the protective layer may be 25 MPa or more. The storage modulus of the protective layer may be 100 MPa or less. The storage modulus of the protective layer may be 90 MPa or less.

The protective layer may have a storage modulus of 20 MPa or more as measured at 50° C. The storage modulus of the protective layer may be 25 MPa or more. The storage modulus of the protective layer may be 100 MPa or less. The storage modulus of the protective layer may be 90 MPa or less.

The protective layer may have a storage modulus of 25 MPa or more as measured at 10° C. The storage modulus of the protective layer may be 30 MPa or more. The storage modulus of the protective layer may be 120 MPa or less. The storage modulus of the protective layer may be 110 MPa or less.

The protective layer may have a storage modulus of 30 MPa or more as measured at 0° C. The storage modulus of the protective layer may be 35 MPa or more. The storage modulus of the protective layer may be 130 MPa or less. The storage modulus of the protective layer may be 120 MPa or less.

### Composition of Protective Layer

The protective layer includes a polyether-block-amide copolymer resin.

The polyether-block-amide copolymer resin may include a polyamide region and a polyether region. The polyamide region may include a semi-crystalline region and may be relatively rigid. The polyether region may include an amorphous region and may be relatively flexible. The polyamide region and the polyether region may simultaneously impart excellent mechanical strength and flexibility to the protective layer.

The polyether-block-amide copolymer may result from condensation polymerization of a polyether block including a reactive end and a polyamide block including a reactive end.

The polyether-block-amide copolymer may be configured such that a polyamide having two or more carboxyl groups in the molecule and a polyether having two or more hydroxyl groups in the molecule are bound to each other.

The polyether-block-amide copolymer may be a condensation polymer including a polyamide block including a dicarboxylic end and a polyoxyalkylene block including a diamine end. The polyoxyalkylene block may be obtained by cyanoethylation and hydrogenation of an aliphatic α,ω-dihydroxylated polyoxyalkylene block known as polyetherdiol.

The polyether-block-amide copolymer may be a condensation polymer including a polyamide block including a dicarboxylic end and a polyetherdiol block. As such, the polyether-block-amide is polyether ester amide.

For example, a polyamide block including a dicarboxylic chain end may include a condensation polymer of a polyamide precursor in the presence of a chain-limiting dicarboxylic acid. For example, a polyamide block including a diamine chain end may include a condensation polymer of a polyamide precursor in the presence of a chain-limiting diamine.

For example, a polyamide block including a dicarboxylic chain end may include a condensation polymer resulted from reacting an α,ω-aminocarboxylic acid, a lactam, or a dicarboxylic acid and a diamine, in the presence of a chain-limiting dicarboxylic acid. The polyamide block may include Polyamide 12 or Polyamide 6.

The polyether-block-amide copolymer may include blocks having randomly distributed units. By way of example, the following three types of polyamide blocks may be applied.

The first type of polyamide block may include a condensation polymer of a dicarboxylic acid and an aliphatic or aryl aliphatic diamine. The dicarboxylic acid may have 4 to 20 carbon atoms, or 6 to 18 carbon atoms. The aliphatic or aryl aliphatic diamine may have 2 to 20 carbon atoms, or 6 to 14 carbon atoms.

Examples of the dicarboxylic acid may include 1,4-cyclohexanedicarboxylic acid, 1,2-cyclohexyldicarboxylic acid, 1,4-butanedioic acid, adipic acid, azelaic acid, suberic acid, sebacic acid, 1,12-dodecanedicarboxylic acid, 1,14-tetradecanedicarboxylic acid, 1,18-octadecanedicarboxylic acid, terephthalic acid, isophthalic acid, naphthalenedicarboxylic acid, dimerized fatty acid, etc.

Examples of the diamine may include 1,5-tetramethylenediamine, 1,6-hexamethylenediamine, 1,10-decamethylenediamine, 1,12-dodecamethylenediamine, trimethyl-1,6-hexamethylenediamine, 2-methyl-1,5-pentamethylenediamine, isomers of bis(3-methyl-4-aminocyclohexyl) methane (BMACM), 2,2-bis(3-methyl-4-aminocyclohexyl) propane (BMACP), bis(para-aminocyclohexyl) methane (PACM), isophoronediamine (IPD), 2,6-bis(aminomethyl) norbornane (BAMN), piperazine (Pip), meta-xylylenediamine (MXD), and para-xylylenediamine (PXD).

The first type of polyamide block may include PA 412, PA 414, PA 418, PA 610, PA 612, PA 614, PA 618, PA 912, PA 1010, PA 1012, PA 1014, PA 1018, MXD6, PXD6, MXD10, or PXD10.

The second type of polyamide block may include a condensation polymer of at least one α,ω-aminocarboxylic acid and/or at least one lactam having 6 to 12 carbon atoms, in the presence of a dicarboxylic acid having 4 to 12 carbon atoms or a diamine.

Examples of the lactam include caprolactam, oenantholactam, laurolactam, etc. Examples of the α,ω-aminocarboxylic acid include aminocaproic acid, 7-aminoheptanoic acid, 11-aminoundecanoic acid, 12-aminododecanoic acid, etc.

The second type of polyamide block may include Polyamide 11, Polyamide 12, or Polyamide 6.

The third type of polyamide block may include a condensation polymer of at least one α,ω-aminocarboxylic acid (or at least one lactam), at least one diamine, and at least one dicarboxylic acid. As such, the polyamide block may be prepared by condensation polymerization of the following diamine, diacid, and comonomer (or comonomers).

Examples of the diamine may include linear aliphatic diamine, aromatic diamine, diamine having X carbon atoms, etc. Examples of the diacid may include dicarboxylic acid, acid having Y carbon atoms, etc. The comonomer or comonomers {Z} may be selected from among lactams and α,ω-aminocarboxylic acid having Z carbon atoms, and substantially equimolar mixtures of at least one diamine having X1 carbon atoms and at least one dicarboxylic acid having Y1 carbon atoms. Here, the (X1, Y1) is different from (X, Y).

The comonomer or comonomers {Z} may be included in an amount of 50 wt % or less, 20 wt % or less, or 10 wt % or less, based on the total amount of bound polyamide precursor monomers.

Condensation reaction according to the third type may proceed in the presence of a chain limiter selected from among dicarboxylic acids. A dicarboxylic acid having Y carbon atoms may be used as the chain limiter, and the dicarboxylic acid may be introduced in excess relative to the stoichiometry of at least one diamine.

In a variant of the third type, the polyamide block may include a condensation polymer of at least two α,ω-aminocarboxylic acids or at least two lactams having 6 to 12 carbon atoms, or a lactam and an aminocarboxylic acid having different numbers of carbon atoms, in the optional presence of a chain limiter.

Examples of the aliphatic α,ω-aminocarboxylic acid may include aminocaproic acid, 7-aminoheptanoic acid, 11-aminoundecanoic acid, 12-aminododecanoic acid, etc.

Examples of the lactam may include caprolactam, oenantholactam, laurolactam, etc.

Examples of the aliphatic diamine may include hexamethylenediamine, dodecamethylenediamine, trimethylhexamethylenediamine, etc.

An example of the alicyclic diacid may include 1,4-cyclohexanedicarboxylic acid.

Examples of the aliphatic diacid may include butanedioic acid, adipic acid, azelaic acid, suberic acid, sebacic acid, dodecanedicarboxylic acid, dimerized fatty acids (having a dimer content of 98% or more; hydrogenated; such as those available under the trade name Pripol from Uniqema or under the trade name Empol from Henkel), polyoxyalkylene-α, ω-diacids, etc.

Examples of the aromatic diacid may include terephthalic acid, isophthalic acid, etc.

Examples of the alicyclic diamine may include isomers of bis(3-methyl-4-aminocyclohexyl) methane (BMACM) and 2,2-bis(3-methyl-4-aminocyclohexyl) propane (BMACP), bis(para-aminocyclohexyl) methane (PACM), etc.

Examples of the diamine may include isophoronediamine (IPD), 2,6-bis(aminomethyl) norbornane (BAMN), piperazine, etc. Examples of the aryl aliphatic diamine include meta-xylylenediamine (MXD) and para-xylylene diamine (PXD), but the present disclosure is not limited thereto.

Examples of the third type of polyamide block include PA 66/6, PA 66/610/11/12, etc. In PA 66/6, 66 represents a hexamethylenediamine unit condensed with adipic acid, and 6 represents a unit introduced by condensation of caprolactam.

In PA 66/610/11/12, 66 represents a hexamethylenediamine unit condensed with adipic acid, 610 represents a hexamethylenediamine unit condensed with sebacic acid, 11 represents a unit introduced by condensation of aminoundecanoic acid, and 12 represents a unit introduced by condensation of laurolactam.

For example, the polyether block is preferably selected from among one or more polyalkylene ether polyols, particularly polyalkylene ether diols, such as polyethylene glycol (PEG), polypropylene glycol (PPG), polytrimethylene glycol (PO3G), polytetramethylene glycol (PTMG), and mixtures of the protective layer or copolymers of the protective layer. The polyether block may include a polyoxyalkylene block including the NH2 chain end, which block may be introduced by cyanoacetylation of an aliphatic α,ω-dihydroxylated polyoxyalkylene block known as polyetherdiol. Specifically, Jeffamine (e.g., Jeffamine® D400, D2000, ED2003 or XTJ542, commercially available from Huntsman) may be used.

At least one polyether block preferably includes at least one polyether selected from among polyalkylene ether polyols such as PEG, PPG, PO3G, and PTMG, polyethers including NH2 at the chain end and including a polyoxyalkylene block, copolymers in which these are randomly distributed and/or block distributed (ether copolymers), and mixtures of the protective layer.

The polyether block may be produced from any one of polyethylene glycol, polypropylene glycol, polytetramethylene glycol, or combinations thereof.

The polyether block may be copolymerized with a polyamide block including a carboxyl end group to form a polyether-block-amide. The polyether block may be aminated to be converted into polyetherdiamine, and then condensed with a polyamide block including a carboxyl end group, forming a polyether-block-amide. The polyether block may be mixed with a polyamide precursor and a chain limiter to form polyether-block-amide including statistically distributed units.

Examples of the polyether include polyethylene glycol (PEG), polypropylene glycol (PPG), polytetramethylene glycol (PTMG), etc. Polytetramethylene glycol is also known as polytetrahydrofuran (PTHF). The polyether block may be introduced into the polyether-block-amide chain in the form of a diol or diamine, and the polyether block may be referred to as a PEG block, PPG block, or PTMG block.

The number average molar mass of the polyamide block may be 300 g/mol to 15,000 g/mol, or 600 g/mol to 5,000 g/mol. The number average molar mass of the polyether block may be 100 g/mol to 6,000 g/mol, or 200 g/mol to 3,000 g/mol.

The number average molar mass ratio between the polyamide block and the polyether block of the polyether-block-amide copolymer may be 1:0.25 to 1, and the number average molar masses of the polyamide block and the polyether block of the copolymer may be 1000/1000, 1300/650, 2000/1000, 2600/650, or 4000/1000 respectively.

The content of the polyether block based on the total weight of the polyether-block-amide copolymer may be 10 wt % or more. The content may be 40 wt % or more. The content may be 60 wt % or more. The content may be 80 wt % or less.

The content of the polyamide block may be 20 wt % or more based on the total weight of the polyether-block-amide copolymer. The content may be 40 wt % or more. The content may be 90 wt % or less. The content may be 60 wt % or less.

The protective layer having the characteristics described above may have elasticity and hardness controlled simultaneously. Thus, the protective film to which the protective layer is applied may be imparted with excellent long-term durability, and the painted surface may be reliably protected from external impact.

The content may be interpreted as being statistically distributed in the polymer chain.

Examples of the polyether-block-amide copolymer include, but are not limited to, Pebax® and Pebax® Rnew® from Arkema, VESTAMID® E from Evonik, etc.

The protective layer may include 70 wt % or more of the polyether-block-amide copolymer resin. The protective layer may include 80 wt % or more of the polyether-block-amide copolymer resin. The protective layer may include 90 wt % or more of the polyether-block-amide copolymer resin. The protective layer may include 95 wt % or more of the polyether-block-amide copolymer resin. The protective layer may include 99 wt % or more of the polyether-block-amide copolymer resin. The protective layer may include 99.9 wt % or less of the polyether-block-amide copolymer resin.

The protective layer may include an optical absorber. According to the present disclosure, it is possible to effectively reduce deterioration of optical characteristics and mechanical properties of the protective film due to exposure to ultraviolet radiation by controlling the content of the optical absorber included in the protective layer. In addition, it is possible to suppress migration of the optical absorber in the protective layer and prevent the yellowness index of the protective layer from excessively increasing due to the color of the optical absorber alone.

The protective layer may include 0.1 to 5 parts by weight of the optical absorber based on 100 parts by weight of the polyether-block-amide resin. The protective layer may include 0.2 parts by weight or more of the optical absorber based on 100 parts by weight of the polyether-block-amide resin. The protective layer may include 0.35 parts by weight or more of the optical absorber based on 100 parts by weight of the polyether-block-amide resin. The protective layer may include 0.5 parts by weight or more of the optical absorber based on 100 parts by weight of the polyether-block-amide resin. The protective layer may include 3 parts by weight or less of the optical absorber based on 100 parts by weight of the polyether-block-amide resin. The protective layer may include 2 parts by weight or less of the optical absorber based on 100 parts by weight of the polyether-block-amide resin. As such, the yellowing and hardening rate of the protective film may be effectively reduced. In addition, migration of the optical absorber may be suppressed, preventing contamination of the appearance of the film.

The optical absorber may include at least one selected from the group consisting of a benzotriazole-based compound, an oxanilide-based compound, a hydroxybenzophenone-based compound, a hydroxyphenyltriazine-based compound, a benzoic acid ester-based compound, and combinations thereof. These compounds may exhibit excellent compatibility with polyether-block-amide copolymer resins and may effectively absorb ultraviolet radiation to reliably prevent deterioration of the protective film.

Examples of the optical absorber may include BASF's Tinuvin 234, Tinuvin 312, Tinuvin 329, Tinuvin P, Tinuvin 1130, Tinuvin 326, Tinuvin 327, Tinuvin 328, Tinuvin 571, Tinuvin 99-DW, etc.

The protective layer may further include an additive commonly used in the field of protective films. Examples of the additive include activators, blocking inhibitors, heat stabilizers, antistatic agents, impact modifiers, etc.

### Thickness of Protective Layer

The protective layer may have a thickness in a range of 1 μm to 2,000 μm. The thickness of the protective layer may be 10 μm or more. The thickness of the protective layer may be 20 μm or more. The thickness of the protective layer may be 50 μm or more. The thickness of the protective layer may be 100 μm or more. The thickness of the protective layer may be 1,500 μm or less. The thickness of the protective layer may be 1,000 μm or less. The thickness of the protective layer may be 800 μm or less. The thickness of the protective layer may be 500 μm or less. When the protective layer having a thickness falling in the above range is applied to a protective film, the protective film may serve to reliably protect the painted surface from external force caused by stone chips or car wash brushes, and may exhibit appropriate processability for attachment to a vehicle painted surface.

### Protective Film

A protective film according to another example of the present disclosure may further include a coating layer disposed on the protective layer and an adhesive layer disposed beneath the protective layer.

The coating layer may serve to increase surface durability of the protective film and improve anti-fouling properties.

The coating layer may include at least one coating material selected from among an organic component, an inorganic component, and an organic-inorganic composite component. The coating material may include an organic resin. Specifically, the organic resin may be a curable resin or a binder resin.

The coating layer may be a curable coating layer.

The coating layer may include at least one of a urethane acrylate-based compound, an acrylic ester-based compound, an acrylate-based compound, or an epoxy acrylate-based compound, or a cured product of the compound.

The coating layer may be composed of a single layer or two or more layers.

The thickness of the coating layer may be 2 μm or more, 3 μm or more, 5 μm or more, or 7 μm or more, and may also be 50 μm or less, 30 μm or less, 20 μm or less, or 10 μm or less. When the thickness of the protective layer falls in the above range, the coating layer, which is applied at a low thickness, is able to provide durability, such as surface hardness, greater than or equal to a level appropriate for the protective film, and also allows the protective film to be suitably flexible for attachment to a vehicle surface with many curves.

The coating layer may be formed by applying and then curing the composition for preparing a coating layer.

The adhesive layer may exhibit stable adhesion to a painted surface with many curves or folds and may also manifest high transparency. Examples of the material for the adhesive layer may include, but are not limited to, OCA (optically clear adhesive), PSA (pressure sensitive adhesive), etc.

The protective film may be a paint protection film. Specifically, the protective film of the present disclosure may be reliably attached even to a painted surface with folds. Also, it may serve to effectively protect the painted surface from foreign substances such as stone chips.

### Method of Manufacturing Protective Film

A method of manufacturing a protective film according to still another embodiment of the present disclosure includes preparing a resin composition including a polyether-block-amide copolymer resin and manufacturing a laminate of a protective layer and a carrier film by melt-extruding the resin composition and disposing the extruded result on a carrier film.

The resin composition may include a polyether-block-amide copolymer resin. A description of the polyether-block-amide copolymer resin is omitted as it overlaps with that described above. Examples of the polyether-block-amide copolymer resin include PEBAX® and Pebax® Rnew® from Arkema, VESTAMID® E series from Evonik, etc.

The resin composition may further include an optical absorber. A description of the optical absorber is omitted as it overlaps with that described above.

The resin composition may further include an additive commonly applied to protective films. Examples of the additive include activators, blocking inhibitors, heat stabilizers, antistatic agents, impact modifiers, etc.

In manufacturing the laminate, the resin composition may be melt-extruded in a single-screw extruder. In manufacturing the laminate, the resin composition may be melt-extruded in a twin-screw extruder.

In manufacturing the laminate, the resin composition may be melt-extruded at 200° C. to 300° C. As such, the resin composition may be sufficiently mixed and deterioration of the resin composition due to heat may be prevented.

In manufacturing the laminate, a laminate of a protective layer and a carrier film may be prepared by melt-extruding the resin composition and disposing the extruded result on a carrier. The tension of the carrier film may be 2,000 kPa to 4,200 kPa. The tension of the protective layer may be 2,200 kPa or more. The tension of the protective layer may be 2,500 kPa or more. The tension of the protective layer may be 4,200 kPa or less. The tension of the protective layer may be 4,000 kPa or less. As such, the carrier film may serve to stably support the protective layer.

In manufacturing the laminate, the melt-extruded resin composition may be passed between rollers. The rollers may include a first roll and a second roll. The first roll and the second roll may be arranged such that a carrier film laminate may pass between the first roll and the second roll. The first roll may be a casting roll, and the second roll may be a squeezing roll.

As the molten resin composition passes between the rollers, the formed protective layer may be processed to a thickness within a preset range in the present disclosure.

A protective film may be disposed on the laminate as necessary.

The method of manufacturing a protective film may further include forming a coating layer on the protective layer. The method of manufacturing a protective film may further include forming an adhesive layer under the protective layer.

A description of the coating layer and adhesive layer is omitted as it overlaps with that described above.

### Painted Article

A painted article according to yet another embodiment of the present disclosure includes an article having a painted surface and a protective film disposed on the painted surface.

The protective film includes a protective layer. The protective layer includes a polyether-block-amide copolymer resin. The protective layer has a yellowness index deviation dvY of 2.5 or less according to Equation 1.

The article having a painted surface means that at least a portion of the surface thereof is painted with paint or the like. Specifically, the painted article may be means of transportation, such as a vehicle, an airplane, etc.

The protective film may be attached to the painted surface. A description of the protective film is omitted as it overlaps with that described above.

A better understanding of the present disclosure may be obtained through the following examples. These examples are merely set forth to illustrate the present disclosure and are not to be construed as limiting the scope of the present disclosure.

### Preparation Example: Manufacture of Protective Film

Example 1: Pebax® Rnew® 35R53 from Arkema was prepared as a polyether block-polyamide block copolymer resin. A resin composition for manufacturing a protective layer including 99.7 wt % of the resin and 0.3 wt % of Tinuvin 234 from BASF as an optical absorber was fed into an extruder, melt-mixed, and then extruded into a sheet. The melting temperature was set to 200° C. to 300° C.

The extruded sheet was disposed on a carrier film having a tension of 2157.4 kPa to 3628.4 kPa, preparing a carrier film laminate. The laminate was passed between a casting roll and a squeezing roll heated to a temperature of 100° C. to 120° C. Thereafter, the carrier film was removed, manufacturing a protective film. The thickness of the film was set to 150 μm.

Example 2: A protective film was manufactured in the same manner as in Example 1, with the exception that the content of polyether-block-amide copolymer resin in the resin composition for manufacturing a protective layer was changed to 99.1 wt %, and the content of optical absorber was changed at 0.9 wt %.

Example 3: A protective film was manufactured in the same manner as in Example 2, with the exception that Tinuvin 312 from BASF was used as the optical absorber.

Example 4: A protective film was manufactured in the same manner as in Example 2, with the exception that Tinuvin 329 from BASF was used as the optical absorber.

Example 5: A protective film was manufactured in the same manner as in Example 1, with the exception that the content of polyether-block-amide copolymer resin in the resin composition for manufacturing a protective layer was changed to 99.3 wt %, and the content of optical absorber was changed to 0.7 wt %.

Comparative Example 1: A protective film was manufactured in the same manner as in Example 1, with the exception that 100 wt % of polyurethane resin was used as the resin composition for manufacturing a protective layer.

Comparative Example 2: A protective film was manufactured in the same manner as in Example 1, with the exception that 100 wt % of Pebax® Rnew® 35R53 from Arkema, which is a polyether-block-amide copolymer resin, was used as the resin composition for manufacturing a protective layer.

The conditions for the manufacturing process in Examples and Comparative Examples are shown in Table 1 below.

### Evaluation Example: Measurement of Yellowness Index and Haze

The yellowness index of the protective films of Examples and Comparative Examples was measured in D65/10 mode according to ASTM E313. Also, the haze of the samples was measured using a haze meter according to ASTM D 1003. Then, the film was irradiated with UVB-313EL light at a light output of 0.68 W/m² using a G15T82 UVB lamp from Sankyo Denki. The yellowness index and haze of the film when the cumulative light exposure time was 24 hours, 48 hours, 72 hours, 144 hours, 216 hours, 312 hours, and 384 hours were measured. The yellowness index and haze after light irradiation were measured in the same manner as before light irradiation. YIₘₐₓ, YIₘᵢₙ, dvY, Hₘₐₓ, Hₘᵢₙ, and dvH were calculated from the measured values.

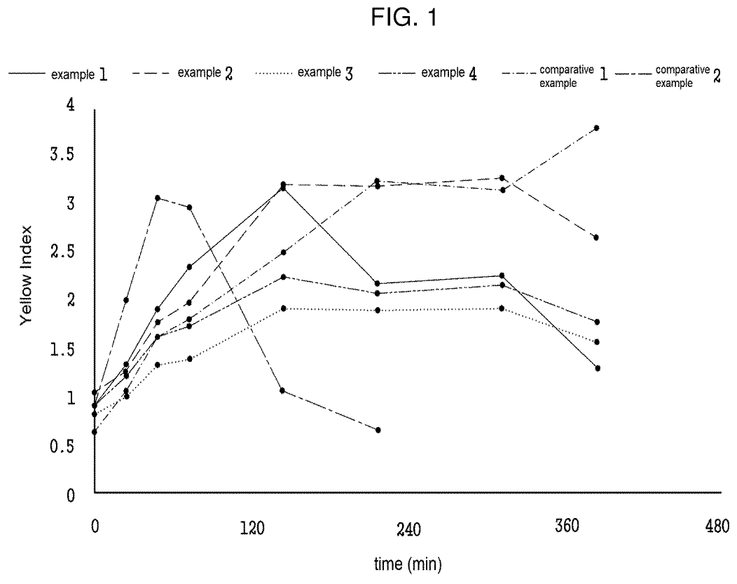

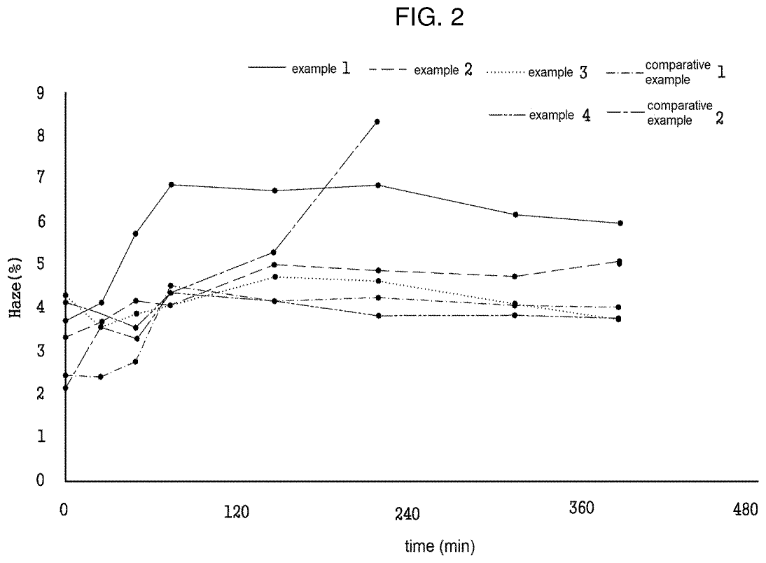

The results of measurement in Examples and Comparative Examples are shown in Tables 2 and 3 below and FIGS. 1 and 2.

### Evaluation Example: Measurement of Transmittance

The transmittance of the protective films of Examples 2 and 5 and Comparative Examples 1 and 2 for light at a wavelength of 350 nm to 450 nm was measured. Specifically, the protective layer was placed on a UV-visible spectrophotometer, model UV-2450 from Shimadzu, and a transmission mode was set, after which the transmittance was measured.

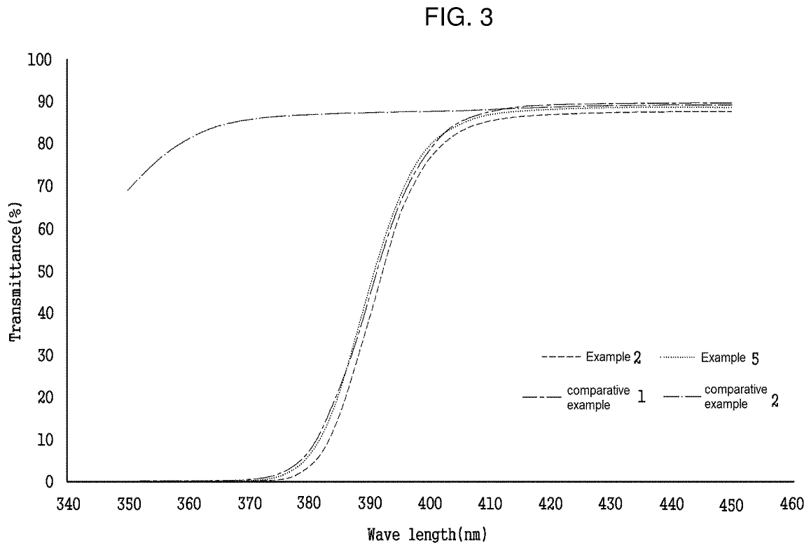

The results of measurement in Examples and Comparative Examples are shown in FIG. 3.

TABLE 1

| | Polyether-block-amide | Optical absorber | Type of |
|---|---|---|---|
| | copolymer resin content | content | optical |
| | (wt %) | (wt %) | absorber |
| Example 1 | 99.7 | 0.3 | Tinuvin 234 |
| Example 2 | 99.1 | 0.9 | Tinuvin 234 |
| Example 3 | 99.1 | 0.9 | Tinuvin 312 |
| Example 4 | 99.1 | 0.9 | Tinuvin 329 |
| Example 5 | 99.3 | 0.7 | Tinuvin 234 |
| Comp. | 100 | 0 | — |
| Example 1 | | | |
| Comp. | 100 | 0 | — |
| Example 2 | | | |

TABLE 2

| | YI* | YI₂₄ | YI₄₈ | YI₇₂ | YI₁₄₄ | YI₂₁₆ | YI₃₁₂ | YI₃₈₄ | YIₘₐₓ | YIₘᵢₙ | dvY |
|---|---|---|---|---|---|---|---|---|---|---|---|
| Example 1 | 0.9 | 1.3 | 1.9 | 2.4 | 3.2 | 2.2 | 2.3 | 1.3 | 3.2 | 0.9 | 2.3 |
| Example 2 | 1.1 | 1.3 | 1.6 | 2 | 3.2 | 3.2 | 3.3 | 2.6 | 3.3 | 1.1 | 2.2 |
| Example 3 | 0.7 | 1 | 1.3 | 1.4 | 1.9 | 1.9 | 1.9 | 1.6 | 1.9 | 0.7 | 1.2 |
| Example 4 | 0.9 | 1.3 | 1.6 | 1.7 | 2.3 | 2.1 | 2.2 | 1.8 | 2.3 | 0.9 | 1.4 |
| Example 5 | — | — | — | — | — | — | — | — | — | — | — |
| Comp. Example 1 | 0.7 | 1.1 | 1.6 | 1.8 | 2.5 | 3.2 | 3.1 | 3.8 | 3.8 | 0.7 | 3.1 |
| Comp. Example 2 | 0.9 | 2 | 3.1 | 2.9 | 1.1 | 0.7 | — | — | 3.1 | 0.7 | 2.4 |

YI is the yellowness index of the protective film before light irradiation.

TABLE 3

| | H* | H₂₄ | H₄₈ | H₇₂ | H₁₄₄ | H₂₁₆ | H₃₁₂ | H₃₈₄ | Hₘₐₓ | Hₘᵢₙ | dvH |
|---|---|---|---|---|---|---|---|---|---|---|---|
| | (%) | (%) | (%) | (%) | (%) | (%) | (%) | (%) | (%) | (%) | (%) |
| Example 1 | 3.6 | 4.1 | 5.8 | 6.9 | 6.7 | 6.8 | 6.2 | 5.9 | 6.9 | 3.6 | 3.3 |
| Example 2 | 3.4 | 3.6 | 4.2 | 4.1 | 5 | 4.8 | 4.7 | 5.1 | 5.1 | 3.4 | 1.7 |
| Example 3 | 4.2 | 3.6 | 3.8 | 4 | 4.7 | 4.6 | 4.2 | 3.8 | 4.7 | 3.6 | 1.1 |
| Example 4 | 4.1 | 3.9 | 3.6 | 4.2 | 4.1 | 3.8 | 3.8 | 3.8 | 4.2 | 3.6 | 0.6 |
| Example 5 | — | — | — | — | — | — | — | — | — | — | — |
| Comp. Example 1 | 2.3 | 2.3 | 2.8 | 4.4 | 4.1 | 4.2 | 4.1 | 4 | 4.4 | 2.3 | 2.1 |
| Comp. Example 2 | 2.1 | 3.5 | 3.2 | 4.2 | 5.2 | 8.3 | — | — | 8.3 | 2.1 | 6.2 |

H is a haze value of the protective film before light irradiation.

As shown in Table 2, the dvY value was 2.5 or less in Examples 1 to 5 but was greater than 3 in Comparative Example 1. This indicates that the film of Examples exhibited superior yellowing resistance compared to the film made of urethane material.

The YI₄₈ value was 2 or less in Examples 1 to 5 but was greater than 3 in Comparative Example 2. This indicates that the rate of increase in yellowing due to exposure to ultraviolet radiation in Examples was very low compared to Comparative Example 2 in which no optical absorber was used.

As shown in Table 3, the dvH value was 5% or less in Examples 1 to 5 but was greater than 6% in Comparative Example 2. This indicates that the extent of increase in haze in the film of Examples was reduced compared to Comparative Example 2 in which no optical absorber was used.

In Comparative Example 2, after the cumulative light exposure time exceeded 312 hours, excessive hardening occurred in the film, resulting in mechanical properties unsuitable for use as a protective film.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A protective film comprising a protective layer,
wherein the protective layer comprises a polyether-block-amide copolymer resin,
wherein YIₙ is a yellowness index measured after irradiating the protective layer with UVB-313EL light at an intensity of 0.68 W/m² for n hours,
wherein the protective layer has a yellowness index deviation (dvY) of 2.5 or less, as defined by Equation (1):
$$dvY = {YI}_{max} - {YI}_{min} \qquad Equation ( 1 )$$
wherein:
YIₘₐₓ is the maximum value among the yellowness indices YI₀, YI₂₄, YI₄₈, YI₇₂, YI₁₄₄, YI₂₁₆, YI₃₁₂, and YI₃₈₄; and
YIₘᵢₙ is the minimum value among the same set of yellowness indices.

2. The protective film of claim 1,
wherein the YIₘₐₓ is the maximum value, and the YIₘᵢₙ is the minimum value, among YIₙ values measured at n=0, 24, 48, 72, 144, 216, 312, and 385 hours.

3. The protective film of claim 1,
wherein the YI value measured after 48 hours of UVB-313EL irradiation (YI₄₈) is 2.8 or less.

4. The protective film of claim 1,
wherein the YI value measured after 384 hours of UVB-313EL radiation (YI₃₈₄) is 3.5 or less.

5. The protective film of claim 1,
wherein the protective layer has a haze deviation (dvH) of 5% or less, as defined by Equation (2):
$$dvH = {H}_{max} - {H}_{min} \qquad Equation ( 2 )$$
wherein:
Hₙ is a haze value measured after irradiating the protective layer with UVB-313EL light at an intensity of 0.68 W/m² for n hours;
Hₘₐₓ is the maximum value among H₀, H₂₄, H₄₈, H₇₂, H₁₄₄, H₂₁₆, H₃₁₂, and H₃₈₄; and
Hₘᵢₙ is the minimum value among the same set of haze values.

6. The protective film of claim 5,
wherein the maximum haze value (Hₘₐₓ) among H₀, H₂₄, H₄₈, H₇₂, H₁₄, H₂₁₆, H₃₁₂, and H₃₈₄ is 7% or less.

7. The protective film of claim 1,
wherein the protective layer further comprises an optical absorber, and
wherein the protective layer has a transmittance of 20% or less for light having a wavelength of 360 nm.

8. The protective film of claim 1,
wherein the protective layer further comprises an optical absorber, and
wherein the optical absorber is present in an amount of 0.1 to 5 parts by weight per 100 parts by weight of the polyether-block-amide resin.

9. The protective film of claim 1,
further comprising a coating layer disposed on the protective layer, and an adhesive layer disposed beneath the protective layer.

10. The protective film of claim 1,
wherein the protective film is a paint protection film.

11. The protective film of claim 8,
wherein the optical absorber comprises at least one selected from the group consisting of a benzotriazole-based compound, an oxanilide-based compound, a hydroxybenzophenone-based compound, a hydroxyphenyltriazine-based compound, a benzoic acid ester-based compound, and combinations thereof.

12. The protective film of claim 1,
wherein the protective layer has a thickness in a range of 1 μm to 2,000 μm.

13. A protective film, comprising:
a protective layer;
a coating layer disposed on the protective layer; and
an adhesive layer disposed beneath the protective layer,
wherein the protective layer has a haze deviation (dvH) of 5% or less, as defined by Equation (1):
$$dvH = {H}_{max} - {H}_{min} \qquad Equation ( 1 )$$
wherein:
Hₙ is a haze value measured after irradiating the protective layer with UVB-313EL light at an intensity of 0.68 W/m² for n hours;
Hₘₐₓ is the maximum value among H₀, H₂₄, H₄₈, H₇₂, H₁₄₄, H₂₁₆, H₃₁₂, and H₃₈₄; and
Hₘᵢₙ is the minimum value among the same set of haze values.

14. The protective film of claim 13,
wherein the maximum haze value (Hₘₐₓ) among H₀, H₂₄, H₄₈, H₇₂, H₁₄₄, H₂₁₆, H₃₁₂, and H₃₈₄ is 7% or less.

15. The protective film of claim 13,
wherein the protective layer further comprises an optical absorber and a polyether-block-amide copolymer resin, and
wherein the protective layer has a transmittance of 20% or less for light having a wavelength of 360 nm.

16. The protective film of claim 15,
wherein the optical absorber is present in an amount of 0.1 to 5 parts by weight per 100 parts by weight of the polyether-block-amide resin.
